(19) United States
(12) Patent Application Publication
(10) Pub. No.: US 2001/0049746 A1
(43) Pub. Date: Dec. 6, 2001

(54) IP-based communication system between terminals and method thereof

(76) Inventor: Sang-hyun Shin, Suwon-city (KR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/774,008

(22) Filed: Jan. 31, 2001

(30) Foreign Application Priority Data
Jun. 3, 2000 (KR) 00-30584

(51) Int. Cl. G06F 15/173

(52) U.S. Cl. 709/239

(57) ABSTRACT

A communication system which allows IP-based communication regardless of whether an Internet protocol (IP) connection exists in a mobile telephone network, and a method thereof are provided. The method includes the steps of receiving a request for an IP address of the other terminal, the request being made using a telephone number, checking whether or not an IP address corresponding to the telephone number is registered upon receipt of the request, and assigning an IP address of the other terminal corresponding to information from an IP address server, if the IP address is not registered. Thus, in a mobile telephone network using a telephone number, a terminal can carry out IP-based video and audio communications with the other terminal via a name server or network, regardless of an IP connection of the other terminal.

### BACKGROUND OF THE INVENTION

1. Field of the Invention

The present invention relates to an Internet protocol (IP)-based communication system in a mobile telephone network, and method thereof, and more particularly, to a communication system which allows IP-based communication regardless of whether an IP connection exists in a mobile communication network. The present application is based on Korean Patent Application No. 2000-30584 filed Jun. 3, 2000, which is incorporated herein by reference.

2. Description of the Related Art

Referring to FIG. 1, a communication system between terminals in a conventional mobile telephone network will now be described briefly. A communication system as shown in FIG. 1, includes a terminal 110, a base station 120, and an interworking function (IWF) 130 on a sending side, and a terminal 160, a base station 150, and an IWF 140 on a receiving side. The communication system of FIG. 1 enables communication between terminals based on an IP address or a telephone number. In a mobile telephone network, one terminal 110 calls another terminal 160 through the base stations 120 and 150 using a telephone number. In an IP-based communication system, the terminal 110 is assigned an IP address from the IWF 130 through the base station 120, and receives data from a web server (not shown) in order to browse the web, or receives an e-mail from an e-mail server (not shown).

However, since the other terminal 160 does not have an IP connection in the conventional communication system, IP-based communication cannot be made between the two terminals 110 and 160. Furthermore, even if the other terminal 160 makes an IP connection through a point-to-point protocol (PPP), the terminal 110 does not know the IP address of the other terminal 160 and only knows the telephone number. Thus, the terminal 110 is used only for browsing the web and receiving e-mail. Furthermore, if the terminal 110 calls the other terminal 160 over a mobile telephone network, since audio communication itself is made based on a telephone number, IP-based communication between the terminals 110 and 160 such as video communication, Voice over IP (VoIP)-based applications, or chat is not available.

### SUMMARY OF THE INVENTION

To solve the above problems, it is an objective of the present invention to provide a communication method for performing Internet protocol (IP)-based video and audio communication between terminals by assigning an IP address to the other terminal in association with an IP address server.

It is another objective of the invention to provide a communication system using the above-mentioned communication method.

Accordingly, to achieve the above objectives, the present invention provides a method for performing an Internet protocol (IP)based communication between wireless terminals, the method comprising the steps of: receiving a request for an IP address of a second terminal from a first terminal, the request being made using a telephone number; upon receipt of the request, checking whether or not an IP address corresponding to the telephone number is registered; and if the IP address is not registered, assigning an IP address to the second terminal corresponding to information from an IP address server.

The present invention also provides a communication system having a terminal, an Internet protocol (IP) address server, a name server for providing an IP address at the request of the terminal, wherein the name server includes a database for storing IP addresses corresponding to telephone numbers of terminals, and a controller which assigns an IP address to another terminal corresponding to information from the IP address server, if the IP address of the other terminal that is requested by the present terminal using a telephone number is not registered, and registers the assigned IP address in the database.

### BRIEF DESCRIPTION OF THE DRAWINGS

The above objectives and advantages of the present invention will become more apparent by describing in detail a preferred embodiment thereof with reference to the attached drawings in which:

FIG. 1 illustrates the configuration of a conventional communication system;

FIG. 2 illustrates an Internet protocol (IP)-based communication system according to the present invention;

FIG. 3 is a detailed diagram showing the name server of FIG. 2;

FIG. 4 illustrates a table in the database of FIG. 3, in which telephone numbers and IP addresses are registered; and

FIG. 5 is a flowchart showing a method of performing an IP-based communication between terminals according to the present invention.

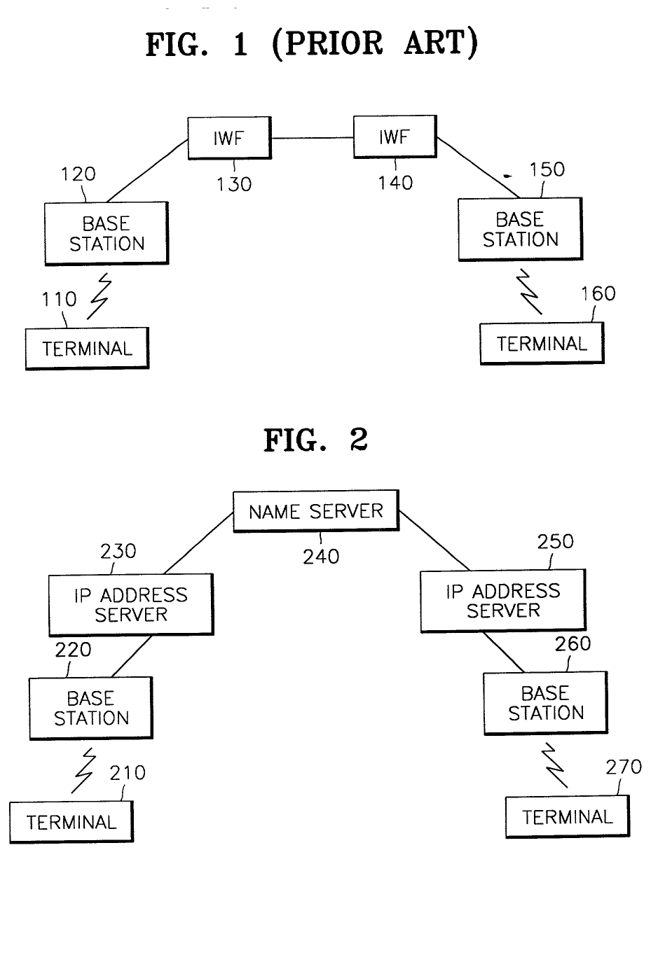

### DETAILED DESCRIPTION OF THE INVENTION

Referring to FIG. 2, a communication system includes terminals 210 and 270, base stations 220 and 260, Internet protocol (IP) address servers 230 and 250, and a name server 240. In this case, the terminals 210 and 270 can perform functions such as video communication or Internet communication, and they are provided with a key pad or touch screen so that a command can be entered and converted into a radio frequency (RF) signal suitable for data services.

Referring to FIG. 2, the terminal 210 attempts an IP-based call to the other terminal 270 using a telephone number. In this case, the terminal 210 transmits a call signal to the other terminal 270 through several layers. For example, in a network layer, the call signal may be transmitted in IP-based packets, each packet including a source address, a destination address, and data, and the addresses of the terminal 210 and the other terminal 270 are set as the source address and the destination address, respectively. Furthermore, in a physical layer, the call signal is transmitted using a wireless protocol such as interim standard (IS)-95.

The base stations 220 and 260 modulate/demodulate wireless data in the form of an RF signal to relay the data between the terminals 210 and 270 and the IP address servers 230 and 250. The IP address servers 230 and 250 relay IP-based data between the base stations 220 and 260 and the name server 240, and provide IP addresses at the request of the terminals 210 and 270. The name server 240 manages telephone numbers and an IP addresses of terminals, and if the terminals 210 and 270 request an IP address assigned to a specific telephone number, it provides a response to this request. Furthermore, when terminal 210 requests the IP address of the other terminal 270, if the other terminal 270 does not make an IP connection and thus does not have an IP address, the name server 240 assigns an IP address to the other terminal 270 corresponding to information from the IP address servers 230 and 250, and then registers the assigned IP address in a database. At the same time, the name server 240 transmits the corresponding IP address to the terminal 210. In this case, the name server 240 sends and receives data to and from the IP address servers 230 and 250, using Transmission Control Protocol/Internet Protocol (TCP/IP), or User Datagram Protocol/Internet Protocol (UDP/IP).

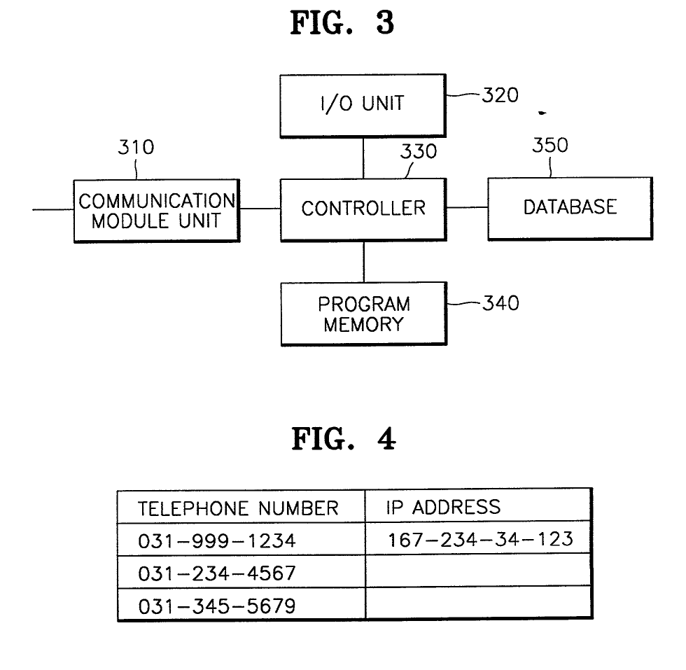

FIG. 3 is a detailed diagram of the name server 240. Referring to FIG. 3, a communication module unit 310 is an interface for sending and receiving IP-based data to/from external devices such as the IP address servers 230 and 250. A controller 330 registers telephone numbers related to the terminals 210 and 270 and processes requests for translation of those telephone numbers into IP addresses, both of which are received from the communication module unit 310. If the controller 330 receives a request to translate a specific telephone number to its corresponding IP address, it handles the response to this request. A program memory 340 stores a program for operating the controller 330. A database 350 stores telephone numbers and IP addresses determined by the controller 330. An input/output (I/O) unit 320 inputs a command to the controller 330, and displays data on a screen.

FIG. 4 shows an embodiment of the database 350 of FIG. 3. Referring to FIG. 4, the IP address for the telephone number “031-999-1234” of the terminal 210 is registered as “167-234-34-123,” whereas an IP address for the telephone number of the other terminal 270 is not registered.

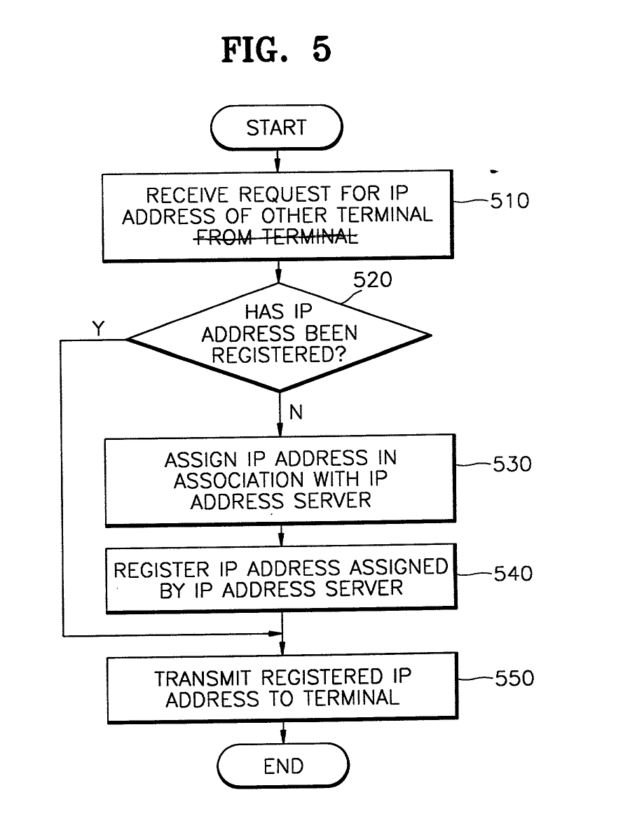

FIG. 5 is a flowchart showing a method for performing an IP-based communication between terminals according to the invention. First, the terminal 210 sends a request to the name server 240 for an IP address of the other terminal 270 using a telephone number (“031-234-4567,” for example) (step 510). In this case, the terminal 210 sets the address of the name server 240 to a destination address within a wireless protocol for data transmission. Next, the name server 240 checks whether or not the requested IP address of the other terminal 270 is registered in the database 350 as shown in FIG. 4 (step 520).

If the requested IP address for the telephone number (for example, “031-234-4567 in the table of FIG. 4) has not yet been registered in the database 350, the name server 240 assigns an IP address to the terminal 270 corresponding to information from the IP address server 250, and then registers the corresponding IP address in the database 350 (steps 530 and 540). Here, when the IP address server 250 on a receiving side is requested to assign the IP address of the other terminal 270 by the name server 240, it assigns the IP address associated with the other terminal 270. In this case, the name server 240 may transmit a wait message to the terminal 210 while obtaining the IP address of the other terminal 270.

Next, the name server 240 transmits the assigned IP address to the terminal 210. Thus, enabling the terminal 210 to communicate with the other terminal 270 via a network using the assigned IP address.

Meanwhile, if the name server 240 investigates the database 350 to find that the requested IP address is registered in the database 350, it sends the corresponding IP address to the terminal 210, which enables the terminal 210 to communicate with the other terminal 270 using the IP address.

According to another embodiment of the invention, if the other terminal 270 does not establish an IP connection, the terminal 210 sends a notice to the other terminal 270 to establish an IP connection, using a short message service (SMS), which enables the other terminal 270 to actively make an IP connection through a point-to-point protocol (PPP) method.

While this invention has been particularly described with reference to preferred embodiments thereof, it will be understood by those skilled in the art that various changes in form and details may be made therein without departing from the spirit and scope of the invention as defined by the appended claims. For example, the invention has a variety of applications such as terminal-to-terminal IP-based communications including video communication, Voice over IP (VoIP) based applications, or chatting.

As described above, in a mobile telephone network using a telephone number, a terminal can carry out IP-based video and audio communications with the other terminal via a name server or network, regardless of an IP connection of the other terminal.

What is claimed is:

1. A method of performing an Internet protocol (IP)-based communication between wireless terminals, the method comprising the steps of:
(a) receiving a request for an IP address of a second terminal from a first terminal;
(b) upon receipt of the request, checking whether or not an IP address corresponding to the second terminal is registered; and
(c) if the IP address is not registered, assigning an IP address to the second terminal corresponding to information from an IP address server.

2. The method of claim 1, wherein in the step (a), the request for an IP address is made using a telephone number, and wherein in the step (b), checking whether or not an IP address corresponds to the second terminal by checking whether the telephone number corresponds to the second terminal.

3. The method of claim 1, if the IP address is not registered, further comprising the step of sending a notice requesting the second terminal to establish an IP connection.

4. The method of claim 3, wherein in the step of sending a notice requesting the second terminal to establish an IP connection, said notice is sent using a Short Message Service (SMS).

5. The method of claim 1, if the IP address is registered, further comprising the step of transmitting the IP address to one of a plurality of terminals, said plurality of terminals including said first terminal.

6. The method of claim 5, wherein the IP address is transmitted to said one of a plurality of terminals using transmission control protocol/internet protocol (TCP/IP) or user datagram protocol/internet protocol (UDP/IP).

7. A communication system having a first terminal and a second terminal, an Internet protocol (IP) address server, a name server for providing an IP address at the request of the first terminal, wherein the name server comprises:
a database for storing IP addresses corresponding to telephone numbers of a plurality of terminals, said plurality of terminals including the second terminal; and
a controller which assigns an IP address to the second terminal corresponding to information from the IP address server, if the IP address of the second terminal that is requested by the first terminal using a telephone number is not registered, and registers the assigned IP address in the database.

8. A name server in an internet protocol (IP)-based communication system comprising:
a communication module unit for sending and receiving IP-based data;
a controller for registering telephone numbers and requests for translation of telephone numbers into IP addresses; and
a database for storing IP addresses and telephone numbers as determined by the controller.

9. The name server of claim 8, wherein the name server further comprises a memory for storing a program for operating the controller.

10. The name server of claim 8, wherein the communication module unit sends and receives IP-based data to and from external devices.

11. The name server of claim 9, wherein the external devices include IP address servers.

12. The name server of claim 8, wherein the controller receives requests for translation of telephone numbers into IP addresses from the communication module unit.
